(19) United States
(12) Patent Application Publication
(10) Pub. No.: US 2024/0351503 A1
(43) Pub. Date: Oct. 24, 2024

(54) TRAILER SYSTEM FOR TRANSPORTING GRANULAR MATERIAL

(71) Applicant: Maxxim Industries II S.A.P.I. de C.V, Cuauhtemoc (MX)

(72) Inventors: Christopher Alexander de la Mora, Houston, TX (US); Johan Blatz Krahn, Cuauhtemoc (MX); German Gomez Ortega, Cuauhtemoc (MX)

(21) Appl. No.: 18/640,701

(22) Filed: Apr. 19, 2024

Related U.S. Application Data
(60) Provisional application No. 63/497,152, filed on Apr. 19, 2023.

(51) Int. Cl. B60P 1/64; B60P 1/56; B60P 3/00; B62D 53/00

(52) U.S. Cl. CPC B60P 1/6418; B60P 1/56; B60P 3/00; B62D 53/005

(57) ABSTRACT

A trailer for transporting a granular material that includes a front section configured to couple to a truck. The trailer further includes a storage section configured to hold the granular material and a back section that includes a connector system. The connector system includes a reinforced component coupled to a chassis of the trailer, where the reinforced component increases the rigidity of the chassis. The reinforced component includes a steel plate and a box structure that includes rearward metal beams coupled to the chassis and extending in a rearward direction and a metal beam coupled between the rearward metal beams and coupled to the steel plate to extend a tow hook from the chassis. The connector system also includes a tow hook coupled to the reinforced component, where the first tow hook is configured to couple to a second trailer.

### CROSS REFERENCE

This application claims the benefit of U.S. Provisional Application No. 63/497,152 filed on Apr. 19, 2023 and entitled “TRAILER SYSTEM”. The contents of U.S. Provisional Application No. 63/497,152 are incorporated by reference herein in their entirety.

### BACKGROUND

Fracking sand plays an important role in fracturing processes, such as fracturing a shale layer. Transporting the sand from one location to another can be a burdensome and costly endeavor due to the density and volume of sand used in fracturing processes.

### SUMMARY

In general, embodiments described herein relate to a trailer system for transporting a granular material, the trailer system including a first trailer that includes a first front section configured to couple to a truck. The first trailer further includes a first storage section configured to hold granular material and a first back section that includes a first connector system. The first connector system includes a first reinforced component coupled to a first chassis of the first trailer, where the first reinforced component increases the rigidity of the first chassis. The first connector system also includes a first tow hook coupled to the first reinforced component, where the first tow hook is configured to receive a first member of a first dolly. The first dolly includes multiple axles and a first hitch. The trailer system also includes a second trailer that includes a second front section configured to couple to the first hitch. The second trailer further includes a second storage section configured to hold granular material and a second back section that includes a second connector system. The second connector system includes a second reinforced component coupled to a second chassis of the second trailer, where the second reinforced component increases the rigidity of the second chassis. In addition, the second connector system includes a second tow hook coupled to the second reinforced component, where the second tow hook is configured to receive a second member of a second dolly. The second dolly includes multiple axles and a second hitch. In addition, the trailer system includes a third trailer that includes a third front section configured to couple to the second hitch and a third storage section configured to hold granular material.

In general, embodiments described herein relate to a trailer system for transporting a granular material, the trailer system including a first trailer that includes a first front section configured to couple to a truck. The first trailer further includes a first storage section configured to hold granular material and a first back section that includes a first connector system. The first connector system includes a first reinforced component coupled to a first chassis of the first trailer, where the first reinforced component increases the rigidity of the first chassis. The first connector system also includes a first tow hook coupled to the first reinforced component, where the first tow hook is configured to couple to a second trailer. The trailer system also includes a second trailer that includes a second front section configured to couple to the first tow hook. The second trailer further includes a second storage section configured to hold granular material and a second back section that includes a second connector system. The second connector system includes a second reinforced component coupled to a second chassis of the second trailer, where the second reinforced component increases the rigidity of the second chassis. In addition, the second connector system includes a second tow hook coupled to the second reinforced component, where the second tow hook is configured to receive a third trailer.

In general, embodiments described herein relate to a trailer for transporting a granular material that includes a front section configured to couple to a truck. The trailer further includes a storage section configured to hold the granular material and a back section that includes a connector system. The connector system includes a reinforced component coupled to a chassis of the trailer, where the reinforced component increases the rigidity of the chassis. The reinforced component includes a steel plate and a box structure that includes rearward metal beams coupled to the chassis and extending in a rearward direction and a metal beam coupled between the rearward metal beams and coupled to the steel plate to extend a tow hook from the chassis. The connector system also includes a tow hook coupled to the reinforced component, where the first tow hook is configured to couple to a second trailer.

### BRIEF DESCRIPTION OF DRAWINGS

Certain embodiments will be described with reference to the accompanying drawings. However, the accompanying drawings illustrate only certain aspects or implementations by way of example and are not meant to limit the scope of the claims.

Specific embodiments will now be described with reference to the accompanying figures.

FIG. 1 shows a perspective view of a trailer system in accordance with one or more embodiments.

FIG. 2 shows a perspective view of a two-trailer system in accordance with one or more embodiments.

FIG. 3 shows a perspective view of a three-trailer system in accordance with one or more embodiments.

FIG. 4 shows a perspective view of a connector system connecting two trailers in accordance with one or more embodiments.

FIG. 5 shows a perspective view of a portion of a connector system in accordance with one or more embodiments.

FIG. 6 shows a perspective view of a coupling between a connector system and a chassis of a trailer in accordance with one or more embodiments.

FIG. 7 shows a perspective view of a chassis of a trailer in accordance with one or more embodiments.

FIG. 8 shows a perspective view of a trailer in accordance with one or more embodiments.

FIG. 9 shows a perspective view of a hopper system in accordance with one or more embodiments.

### DETAILED DESCRIPTION

In the below description, numerous details are set forth as examples of embodiments described herein. It will be understood by those skilled in the art, and having the benefit of this Detailed Description, that one or more embodiments described herein may be practiced without these specific details and that numerous variations or modifications may be possible without departing from the scope of the embodiments described herein. Certain details known to those of ordinary skill in the art may be omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

One challenge of handling fracking sand is the transportation of the fracking sand to well sites. Due to the density and volume of fracking sand needed at remote sites, large amounts of sand by volume and weight are needed at oil and gas well sites which may be spread out over great distances. Further, transportation to the well sites may include driving on both private property and public highways, which each may have different rules and regulations regarding weight limits of vehicles. For example, public highways may restrict vehicles to certain weight limits while private property may have higher restrictions or no restrictions concerning vehicle weight limits. In addition, the weight limits generally apply to the combined weight of the vehicle and cargo. Further, trucks that tow cargo may be capable of towing weights far in excess of the weight limits on public and/or private highways.

In general, embodiments disclosed herein provide a trailer system that has minimized the weight of the trailer itself while maintaining strength sufficient to carry full loads of sand, thereby enabling a greater amount of sand to be transported per trailer. Further, embodiments disclosed herein provide a trailer system that may link to other trailers, thereby increasing the amount of sand that can be transported by a single truck.

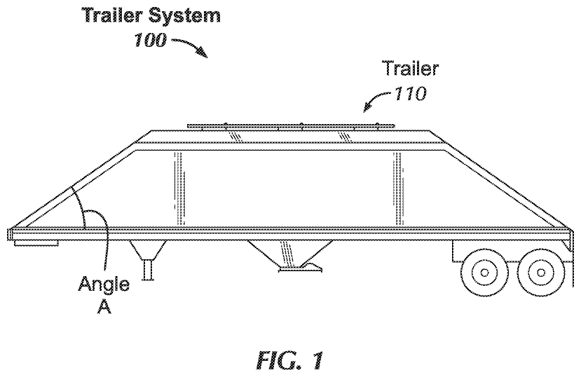

FIG. 1 shows a perspective view of a trailer system (100) in accordance with one or more embodiments. The trailer system (100) includes a trailer (110) that is configured to receive and hold sand such as fracking sand.

Generally, the trailer (110) may be logically split into three sections, a front section, a storage section, and a back section. In one or more embodiments, the front section includes the portions of the trailer (110) used for coupling to another object, such as a truck, dolly, or another trailer. In one or more embodiments, the storage section includes the portions of the trailer (110) used for receiving, storing, and dispensing the granular material. In one or more embodiments, the back section includes the portions of the trailer (110) used for coupling to other objects, such as a dolly or another trailer. Each of the front section, the storage section, and the back section are described in greater detail below.

The trailer system (100) may have a gross vehicle weight rating of 32, 35, or 40 tons or any rating between 32 and 40 tons. The rating is the total weight of the trailer and any contents contained therein, such as fracking sand. Thus, a trailer rated for 35 tons can weigh up to 35 tons while remaining within the limits specified by the manufacturer. Further, to accommodate such a weight, the height of the trailer (110) from the bottom rail to the top of the trailer may be 78, 84, 90, or 96 inches tall, or any height between 78 and 96 inches.

In addition, many jurisdictions have rules regarding the amount of weight carried by each axle of a vehicle driven on public roads. In the current embodiment, the trailer (110) includes two axles in the back section and the front section may couple to an object having two or more axles, thereby providing four axles to support the weight of the trailer (110). In one or more embodiments, the trailer (110) may include more axles to comply with alternative rules and/or provide additional support.

Further, the angle A may be 30, 35, or 40 degrees or any angle between 30 and 40 degrees. The generally trapezoidal side cross-section of the trailer (110) provided additional strength, particularly to the side walls of the trailer (110), thereby enabling a greater load of product (e.g., fracking sand) in the trailer, particularly due to the stopping and starting of the trailer (110).

Further, the trailer (110) may include a combination of materials as described below. For example, the trailer (110) may include some lower strength but lighter materials (e.g., aluminum) and some higher strength but heavier materials (e.g., steel) to provide a lower overall weight while also maintaining strength sufficient to hold large loads.

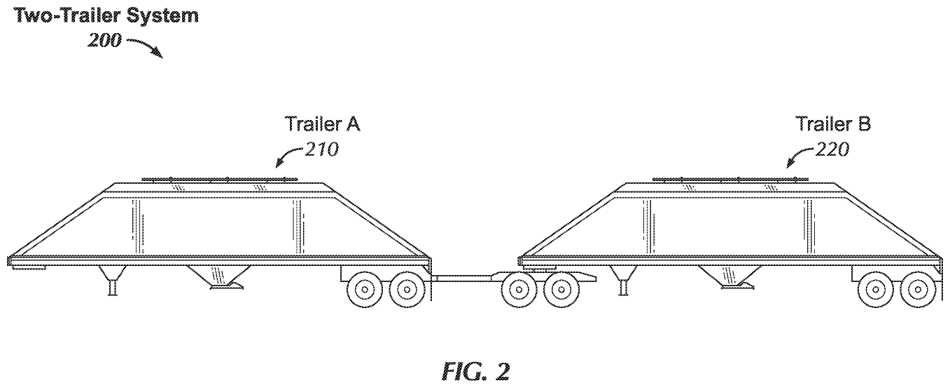

FIG. 2 shows a perspective view of a two-trailer system (200) in accordance with one or more embodiments. The two-trailer system (200) includes two trailers, trailer A (210) and trailer B (220). Each of the trailers (210, 220) may be the same as the trailer depicted in FIG. 1. Further, one of the trailers (210, 220) may be the same as the trailer depicted in FIG. 1, while the other is a different trailer. For example, a first trailer could be a 35 ton rated trailer and the second trailer could be a 27 ton rated trailer.

Further, towing one of the trailers (210, 220) may cause a vehicle (e.g., a truck and a trailer) to be at the maximum weight allowed by certain roads (e.g., public highways) while the weight limits, or lack thereof, on other roads may allow a truck to tow two trailers. Thus, it is envisioned that two trucks may each tow one trailer each during the portion of a trip that is along public highways. Then, after arriving at a private road, one truck may disengage its trailer, and the other truck may engage a second trailer to its trailer. Thus, one truck may complete the trip towing two trailers, while the second truck is free to perform other operations, thereby increasing the time available to the truck operators, reducing overall fleet (e.g., of a number of trucks operated by an entity) carbon footprint, and increasing fleet efficiency.

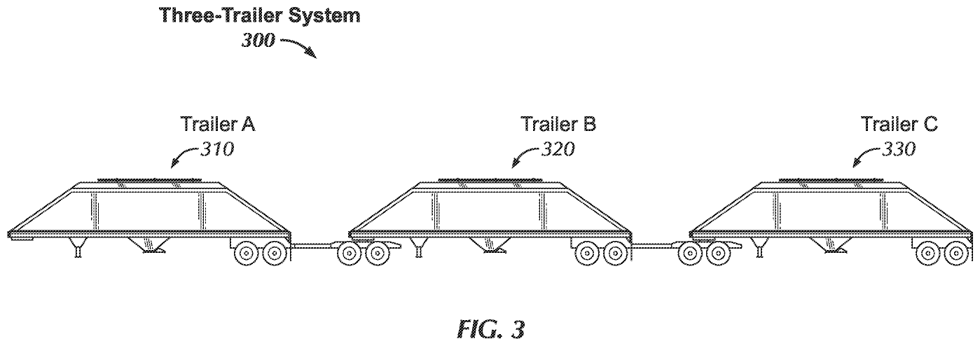

FIG. 3 shows a perspective view of a three-trailer system (300) in accordance with one or more embodiments. The three-trailer system (300) includes three trailers, trailer A (310), trailer B (320), and trailer C (330). Each of the trailers (310, 320, 330) may be the same as the trailer depicted in FIG. 1. Further, one or two of the trailers (310, 320, 330) may be the same as the trailer depicted in FIG. 1, while the other one or two are different trailers. For example, a first trailer could be a 35 ton rated trailer, a second trailer could be a 27 ton rated trailer, and a third trailer could also be a 35 ton rated trailer.

Further, towing one of the trailers (310, 320, 330) may cause a vehicle (e.g., a truck and a trailer) to be at the maximum weight allowed by certain roads (e.g., public highways) while the weight limits, or lack thereof, on other roads may allow a truck to tow three trailers. Thus, it is envisioned that three trucks may each tow one trailer each during the portion of a trip that is along public highways. Then, after arriving at a private road, two trucks may disengage their respective trailers, and the other truck may engage a second trailer to its trailer and a third trailer to the second trailer. Thus, one truck may complete the trip towing three trailers, while the second and third trucks are free to perform other operations, thereby increasing the time available to the truck operators, reducing overall fleet (e.g., of a number of trucks operated by an entity) carbon footprint, and increasing fleet efficiency.

Further, each of the trailers (320, 330) may be coupled to a dolly at the front section of the respective one of the trailers (320, 330) to support the front section during motion.

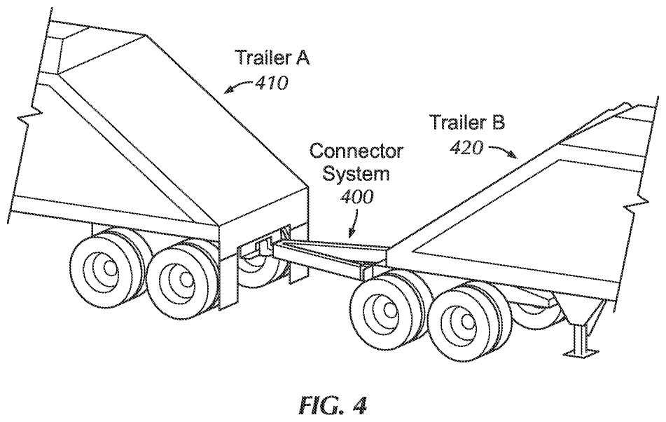

FIG. 4 shows a perspective view of a connector system (400) connecting two trailers (410, 420) in accordance with one or more embodiments. The connector system (400) includes a reinforcement component and a tow hook on trailer A (410) and a supporting structure extending from trailer B (420), for example from a dolly, to connect to the tow hook on trailer A (410). The connecting structure, as depicted uses two rails for form a triangular shape. Other connecting structures may be utilized, including one rail, three rails, etc. and the rails may form other shapes such as straight lines between the two trailers, etc.

In one or more embodiments, the connecting structure extending from trailer B (420) is omitted and the trailer (410) couples directly to the trailer (420) or is coupled to the trailer (420) via a dolly.

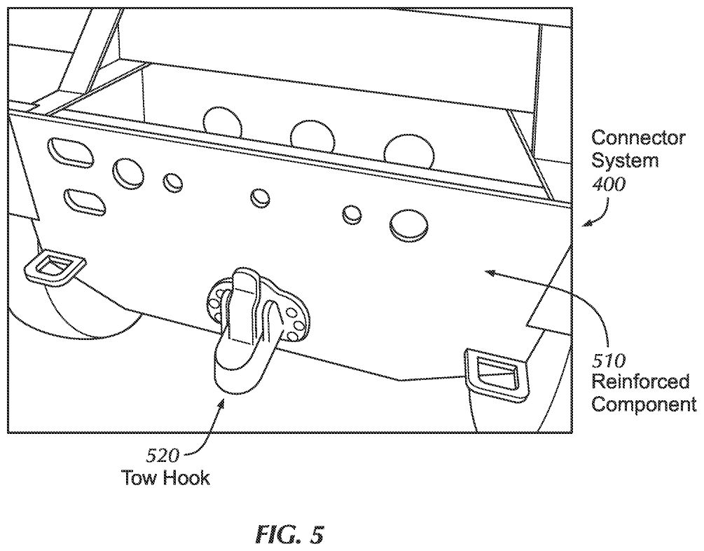

FIG. 5 shows a perspective view of a portion of a connector system (400) in accordance with one or more embodiments. The connector system (400) includes a reinforced component (510) and a tow hook (520).

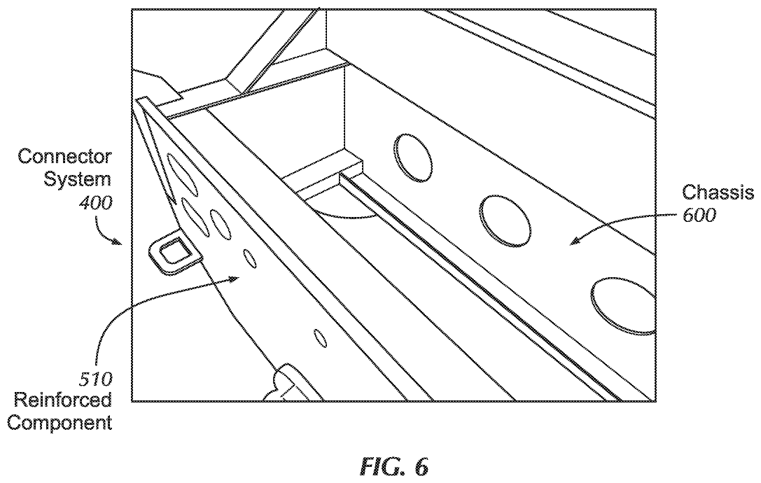

The reinforced component (510) may be a structure that couples to the back side of a trailer and may include different materials than the trailer. For example, the reinforced component (510) may include a plate structure composed of steel or other alloy material. In one or more embodiments, the plate structure is coupled directly to a chassis (600, FIG. 6) of the trailer.

Further, the reinforced component (510) may include the illustrated box structure to extend the connector system (400) apart from the rear of the trailer. In one or more embodiments, the box structure includes rearward metal beams that are coupled to the chassis (600) and extend in a rearward direction from the chassis (600). In one or more embodiments, the box structure also includes a metal cross-beam extending between the rearward metal beams to complete the box-like shape of the box structure. In one or more embodiments, the plate structure couples to the metal cross-beam. In one or more embodiments, the plat structure replaces the cross-beam to form the box-like shape. This box structure may provide an extension on the back section of the trailer that allows for additional space between the rest of the structure of the trailer and an object being towed behind the trailer to more easily enable two trailers to couple to one another without any intervening rails, such as the connecting structure illustrated in FIG. 4.

Further, the reinforced component (510) may include apertures that may provide channels through which other components may pass, such as wires (e.g., wires to connect the trailer lighting systems to the truck). In addition, the apertures in the reinforced component (510) may reduce the weight of the reinforced component (510). Moreover, the reinforced component (510) may be coupled to the trailer through any means, such as by bolts, welds, etc. Further, the reinforced component (510) may couple to a chassis of the trailer.

The tow hook (520) is coupled to the reinforced component (510) via any suitable means including bolt, welds, etc. Further, the form of the tow hook may be any suitable form such a hitch, D-ring, slip hook, etc. Further, the tow hook (520) may be configured to couple to the connecting structure of another trailer via bolts, welds, etc.

FIG. 6 shows a perspective view of a portion of the connector system (400) in accordance with one or more embodiments.

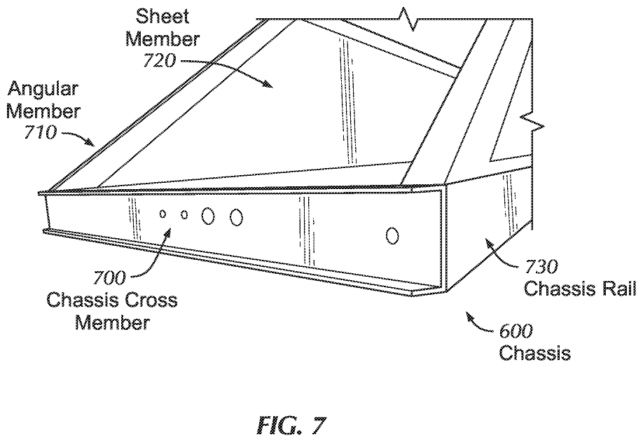

FIG. 7 shows a perspective view of a portion of chassis (600) of a trailer in accordance with one or more embodiments. As shown, the chassis (600) includes one or more chassis rails (730) and one or more chassis cross members (700). The cross members (700) couple to chassis rails (730) at either end of the cross members (700). The cross members (700) couple to the chassis rails (730) at about 90 degree angles to form a generally rectangular structure. Further, the cross members (700) and/or the chassis rails (730) may be composed of lower strength but lighter materials (e.g., aluminum) and/or higher strength but heavier materials (e.g., steel) and any combination thereof. For example, the cross members (700) and/or the chassis rails (730) may be composed of extruded aluminum or steel and may include a thickness of 0.25 inches, 0.375 inches, 0.5 inches, 0.625 inches or any thickness between 0.25 and 0.625 inches. Further, the cross members (700) and/or the chassis rails (730) may include one or more apertures that may provide channels through which other components may pass, such as wires (e.g., wires to connect the trailer lighting systems to the truck). In addition, the apertures in the cross members (700) and/or the chassis rails (730) may reduce the weight of the cross members (700) and/or the chassis rails (730).

Further, the trailer includes angular members (710) and sheet members (720) to provide side supporting structure to contain the material being hauled in the trailer. Further, the angular member (710) and/or the sheet member (720) may be composed of lower strength but lighter materials (e.g., aluminum) and/or higher strength but heavier materials (e.g., steel) and any combination thereof.

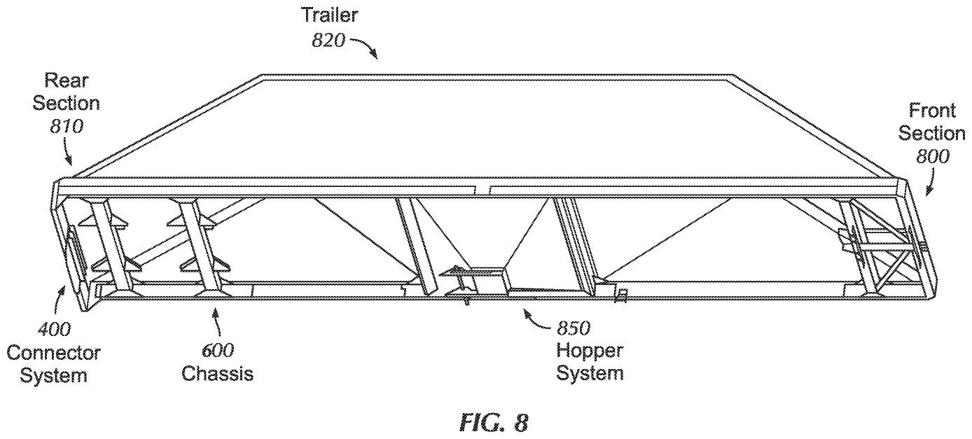

FIG. 8 shows a perspective view of a bottom portion of a trailer (820) in accordance with one or more embodiments. The trailer (820) includes a connector system 400, a chassis (500), a rear section (810), a front section (800), and a hopper system (850).

The connector system (400) as shown does not include an extension section from the back of the trailer (820). The connector system (400), as shown, includes a reinforced plate coupled to the back of the trailer.

The chassis (600) includes rails and cross members. Further, the rails do not extend the length of the trailer (820) as a single piece. For example, one portion of a rail may be composed of a first material and a second portion, which may be a separate piece, may be composed of a second material. Further, the cross members may be included at the front section (800), the rear section (810), and proximate to the hopper system (850). Further, there are additional structural members in the front section (800) and the rear section (810) to provide addition structural support to the trailer at or near the points at which the trailer connects to other members, such as a truck or other trailer. Further, the chassis (600) components in the rear section (810) may be configured to couple to a set of wheels and the supporting structure for the wheels. Further, the chassis (600) components in the front section (800) may be configured to couple to a truck such as the back of the truck, such as a semi-trailer truck. In one or more embodiments, the chassis (600) components in the front section (800) may include and/or be replaced by the chassis (600) components in the rear section (810).

The hopper system (850) may be coupled to the bottom of the trailer (820) along the chassis (500) and extend downward toward the ground. The hopper system (850) may include a cone shape such that a granular material, such as sand or fracking sand, can fall from the body of the trailer, into the hopper system (850), through the hopper system (850), and out of the hopper system (850). As such, the hopper system (850) may provide a structure that enables sand within the trailer (820) to be poured out of the bottom of the trailer (820).

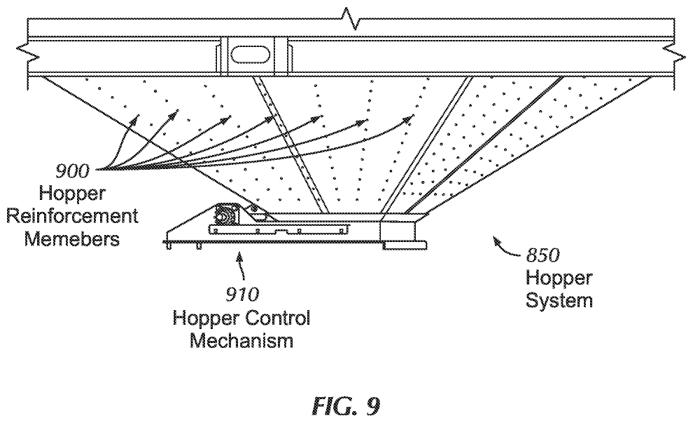

FIG. 9 shows a perspective view of the hopper system (850) in accordance with one or more embodiments. The hopper system (850) includes hopper reinforcement members (900) and a hopper control mechanism (910).

As discussed above, the trailer may be composed of lighter materials, thereby enabling the trailer to carry a higher weight of load materials, such as sand. Due to the larger amount of weight inside the trailer, and with the hopper system (850) being the lowest point in the trailer, the hopper system (850) includes a larger number of hopper reinforcement members (900) than a trailer of comparable size and/or load rating. For example, the hopper reinforcement members (900) may be constructed of higher strength steel alloys, be spaced closer together, or the members are thicker. In one or more embodiments, the hopper reinforcement members (900) are 4 inches, 5 inches, 6 inches, or 7 inches apart, or any spacing between 4 and 7 inches. In one or more embodiments, the hopper reinforcement members (900) include a thickness of 0.25 inches, 0.375 inches, 0.5 inches, 0.625 inches or any thickness between 0.25 and 0.625 inches.

Further, the hopper system (850) includes the hopper control mechanism (910) that is operable to selectively open and close the hopper system (850). As such, the hopper control mechanism (910) includes a metal plate that moves to selectively cover an aperture through the bottom of the hopper system (850). To do so, the hopper control mechanism (910) includes a ratchet system that is operable to move the plate from an open position that allows material to flow out of the hopper system (850) to a closed position that prevents material from flowing out of the hopper system (850).

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A trailer system for transporting a granular material, the trailer system comprising:
a first trailer comprising:
a first front section configured to couple to a truck;
a first storage section configured to hold granular material; and
a first back section comprising a first connector system comprising:
a first reinforced component coupled to a first chassis of the first trailer, wherein the first reinforced component increases the rigidity of the first chassis; and
a first tow hook coupled to the first reinforced component, wherein the first tow hook is configured to receive a first member of a first dolly;
the first dolly comprising:
a first plurality of axles; and
a first hitch;
a second trailer comprising:
a second front section configured to couple to the first hitch;
a second storage section configured to hold granular material; and
a second back section comprising a second connector system comprising:
a second reinforced component coupled to a second chassis of the second trailer, wherein the second reinforced component increases the rigidity of the second chassis; and
a second tow hook coupled to the second reinforced component, wherein the second tow hook is configured to receive a second member of a second dolly;
the second dolly comprising:
a second plurality of axles; and
a second hitch; and
a third trailer comprising:
a third front section configured to couple to the second hitch; and
a third storage section configured to hold granular material.

2. The trailer system of claim 1, wherein the first reinforced component comprises a steel plate.

3. The trailer system of claim 2, wherein the first reinforced component further comprises a box structure to further extend the first tow hook from the first chassis.

4. The trailer system of claim 3, wherein the box structure comprises:
rearward metal beams coupled to the first chassis and extending in a rearward direction; and
a metal beam coupled between the rearward metal beams and is coupled to the steel plate.

5. The trailer system of claim 1, wherein the first trailer, the second trailer, and the third trailer comprise the same gross vehicle weight rating.

6. The trailer system of claim 5, wherein the gross vehicle weight rating is 35 tons.

7. The trailer system of claim 1, wherein at least one of the first trailer, the second trailer, and the third trailer comprises a different gross vehicle weight rating than the remaining trailers.

8. The trailer system of claim 1, wherein the granular material is sand.

9. The trailer system of claim 1, wherein each of the first trailer, the second trailer, and the third trailer each comprise a hopper system configured to release the granular material from a bottom portion of a respective one of the first trailer, the second trailer, and the third trailer.

10. The trailer system of claim 1, wherein the third trailer comprises:
a third back section comprising a third connector system comprising:
a third reinforced component coupled to a third chassis of the third trailer, wherein the third reinforced component increases the rigidity of the third chassis; and
a third tow hook coupled to the third reinforced component, wherein the third tow hook is configured to receive a third member of a third dolly.

11. A trailer system for transporting a granular material, the trailer system comprising:
a first trailer comprising:
a first front section configured to couple to a truck;
a first storage section configured to hold granular material; and
a first back section comprising a first connector system comprising:
a first reinforced component coupled to a first chassis of the first trailer, wherein the first reinforced component increases the rigidity of the first chassis; and
a first tow hook coupled to the first reinforced component, wherein the first tow hook is configured to couple to a second trailer;
the second trailer comprising:
a second front section configured to couple to the first tow hook;
a second storage section configured to hold granular material; and
a second back section comprising a second connector system comprising:
a second reinforced component coupled to a second chassis of the second trailer, wherein the second reinforced component increases the rigidity of the second chassis; and
a second tow hook coupled to the second reinforced component, wherein the second tow hook is configured to receive a third trailer.

12. The trailer system of claim 11, wherein the first reinforced component comprises a steel plate.

13. The trailer system of claim 12, wherein the first reinforced component further comprises a box structure to further extend the first tow hook from the first chassis.

14. The trailer system of claim 13, wherein the box structure comprises:
rearward metal beams coupled to the first chassis and extending in a rearward direction; and
a metal beam coupled between the rearward metal beams and is coupled to the steel plate.

15. The trailer system of claim 11, wherein the first trailer and the second trailer comprise the same gross vehicle weight rating.

16. The trailer system of claim 15, wherein the gross vehicle weight rating is 35 tons.

17. The trailer system of claim 11, wherein the first trailer and the second trailer comprise different gross vehicle weight ratings.

18. The trailer system of claim 11, wherein each of the first trailer and the second trailer each comprise a hopper system configured to release the granular material from a bottom portion of a respective one of the first trailer, the second trailer, and the third trailer.

19. The trailer system of claim 11, wherein the trailer system further comprises:
a third trailer comprising:
a third front section configured to couple to the second tow hook;
a third storage section configured to hold granular material; and
a third back section comprising a third connector system comprising:
a third reinforced component coupled to a third chassis of the third trailer, wherein the third reinforced component increases the rigidity of the third chassis; and
a third tow hook coupled to the third reinforced component, wherein the third tow hook is configured to receive a third member of a third dolly.

20. A trailer for transporting a granular material, the trailer comprising:
a front section configured to couple to a truck;
a storage section configured to hold the granular material; and
a back section comprising a connector system comprising:
a reinforced component coupled to a chassis of the trailer, wherein the reinforced component increases the rigidity of the chassis, and wherein the reinforced component comprises:
a steel plate; and
a box structure comprising:
rearward metal beams coupled to the chassis and extending in a rearward direction; and
a metal beam coupled between the rearward metal beams and coupled to the steel plate to extend a tow hook from the chassis; and
the tow hook coupled to the reinforced component, wherein the tow hook is configured to couple to a second trailer.
